(19) United States
(12) Patent Application Publication
(10) Pub. No.: US 2023/0169617 A1
(43) Pub. Date: Jun. 1, 2023

(54) METHODS AND DEVICES FOR STUDENT ADMISSION MANAGEMENT IN HYBRID CUSTOMER RELATIONSHIP MANAGEMENT (CRM) SYSTEM

(71) Applicants: Sarkar Shamim Ibrahim, Sheffield (GB); SAMS GLOBAL SOLUTIONS LTD., Sheffield (GB)

(72) Inventor: Sarkar Shamim Ibrahim, Sheffield (GB)

(73) Assignee: SAMS GLOBAL SOLUTIONS LTD., Sheffield (GB)

(21) Appl. No.: 17/920,859

(22) PCT Filed: Sep. 10, 2021
(86) PCT No.: PCT/IB2021/000792

§ 371 Date: Oct. 24, 2022

Related U.S. Application Data
(60) Provisional application No. 63/077,161, filed on Sep. 11, 2020.

(51) Int. Cl. G06Q 50/20; G06Q 10/1053

(52) U.S. Cl. CPC G06Q 50/2053; G06Q 10/1053

(57) ABSTRACT

Methods and devices for a hybrid customer relationship management (CRM) system are provided. A recruiting agent is subscribed to the hybrid CRM system in response to subscription information from the recruiting agent at the hybrid CRM system. Registration information of a prospective student is received from the recruiting agent, which establishes a profile of the prospective student in the hybrid CRM system and provides the prospective student with access to the hybrid CRM system. An application request for an institution is received from the prospective student via the hybrid CRM system. The hybrid CRM system determines a commission to be issued to the recruiting agent by the institution upon enrollment of the prospective student at the institution, based on the subscription information.

### PRIORITY

The present application claims priority under 35 U. S.C. § 119(e) to a U.S. Provisional Patent Application filed in the U.S. Patent and Trademark Office on Sep. 11, 2020 and assigned Ser. No. 63/077,161, the contents of which are incorporated herein by reference.

### BACKGROUND

### 1. Field

The present disclosure relates generally to a student admission management, and more particularly, to a hybrid customer relationship management (CRM) system that integrates an application portal for student admission management.

### 2. Description of the Related Art

A CRM system is a database management system that helps manage customer data, supports sales management, delivers actionable insights, and facilitates team communication. A CRM system helps to improve customer relationships by providing a central place to store customer and prospect data, track customer interactions, and share this information. In the field of student admission management, the CRM system provides a recruiting agent with a means to manage information relating to prospective students for educational institutions.

Typically, an application portal requires an agency to send prospective student applications via a recruiting agent's dedicated computer system. Those applications are then forwarded to the recruiting agent's partner educational institutions. Therefore, the application portal acts independent of the CRM system, and significant time and cost are required in order to collaborate with educational institutions and other related vendors.

### SUMMARY

According to an aspect of the disclosure, a method of a cloud server in a hybrid CRM system is provided. A recruiting agent is subscribed to the hybrid CRM system in response to subscription information from the recruiting agent at the hybrid CRM system. Registration information of a prospective student is received from the recruiting agent, which establishes a profile of the prospective student in the hybrid CRM system and provides the prospective student with access to the hybrid CRM system. An application request for an institution is received from the prospective student via the hybrid CRM system. The hybrid CRM system determines a commission to be issued to the recruiting agent by the institution upon enrollment of the prospective student at the institution, based on the subscription information.

According to another aspect of the disclosure, a cloud server includes at least one non-transitory computer readable medium, and at least one controller. The at least one controller, when executing instructions stored in the at least one non-transitory computer readable medium, subscribes a recruiting agent to the hybrid CRM system, in response to subscription information from the recruiting agent at the hybrid CRM system. Registration information of a prospective student is received from the recruiting agent, which establishes a profile of the prospective student in the hybrid CRM system and provides the prospective student with access to the hybrid CRM system. An application request for an institution is received from the prospective student via the hybrid CRM system. The hybrid CRM system determines a commission to be issued to the recruiting agent by the institution upon enrollment of the prospective student at the institution, based on the subscription information.

According to another aspect of the disclosure, a method of a terminal of a recruiting agent in a hybrid CRM system is provided. The hybrid CRM system on a cloud server is subscribed to by submitting subscription information to the hybrid CRM system. Registration information of a prospective student is provided to the hybrid CRM system, which establishes a profile of the prospective student in the hybrid CRM system and provides the prospective student with access to the hybrid CRM system. An application for the prospective student is submitted, via the hybrid CRM system, to an institution requested by the prospective student. A commission to be issued by the institution upon enrollment of the prospective student at the institution is determined via the hybrid CRM system based on the subscription information.

According to another aspect of the disclosure, a terminal is provided that includes at least one non-transitory computer readable medium, and at least one controller. The at least one controller, when executing instructions stored in the at least one non-transitory computer readable medium, subscribes to the hybrid CRM system on a cloud server by submitting subscription information to the hybrid CRM system. Registration information of a prospective student is provided to the hybrid CRM system, which establishes a profile of the prospective student in the hybrid CRM system and provides the prospective student with access to the hybrid CRM system. An application for the prospective student is submitted, via the hybrid CRM system, to an institution requested by the prospective student. A commission to be issued by the institution upon enrollment of the prospective student at the institution is determined via the hybrid CRM system based on the subscription information.

### BRIEF DESCRIPTION OF THE DRAWINGS

The above and other aspects, features, and advantages of the present disclosure will become apparent and be readily appreciated from the following description of embodiments, taken in conjunction with the accompanying drawings, in which:

FIG. 1 is a diagram illustrating a cloud server architecture for providing a hybrid CRM system, according to an embodiment of the disclosure;

FIG. 2 is a diagram illustrating a hybrid CRM system, according to an embodiment of the disclosure;

FIG. 3 is a diagram illustrating components of the hybrid CRM system, according to an embodiment of the disclosure;

FIGS. 4A and 4B are diagrams illustrating cloud server modules for the hybrid CRM system, according to an embodiment of the disclosure;

FIG. 5 is a flowchart illustrating a method for student admission management in the hybrid CRM system, according to an embodiment of the disclosure;

FIG. 6 is a block diagram of a cloud server, according to an embodiment of the disclosure; and

FIG. 7 is a block diagram of an terminal in a network environment, according to an embodiment of the disclosure.

### DETAILED DESCRIPTION

Hereinafter, embodiments of the present disclosure are described in detail with reference to the accompanying drawings. It should be noted that the same elements will be designated by the same reference numerals although they are shown in different drawings. In the following description, specific details such as detailed configurations and components are merely provided to assist with the overall understanding of the embodiments of the present disclosure. Therefore, it should be apparent to those skilled in the art that various changes and modifications of the embodiments described herein may be made without departing from the scope of the present disclosure. In addition, descriptions of well-known functions and constructions are omitted for clarity and conciseness. The terms described below are terms defined in consideration of the functions in the present disclosure, and may be different according to users, intentions of the users, or customs. Therefore, the definitions of the terms should be determined based on the contents throughout this specification.

The present disclosure may have various modifications and various embodiments, among which embodiments are described below in detail with reference to the accompanying drawings. However, it should be understood that the present disclosure is not limited to the embodiments, but includes all modifications, equivalents, and alternatives within the scope of the present disclosure.

Although the terms including an ordinal number such as first, second, etc. may be used for describing various elements, the structural elements are not restricted by the terms. The terms are only used to distinguish one element from another element. For example, without departing from the scope of the present disclosure, a first structural element may be referred to as a second structural element. Similarly, the second structural element may also be referred to as the first structural element. As used herein, the term “and/or” includes any and all combinations of one or more associated items.

The terms used herein are merely used to describe various embodiments of the present disclosure but are not intended to limit the present disclosure. Singular forms are intended to include plural forms unless the context clearly indicates otherwise. In the present disclosure, it should be understood that the terms “include” or “have” indicate existence of a feature, a number, a step, an operation, a structural element, parts, or a combination thereof, and do not exclude the existence or probability of the addition of one or more other features, numerals, steps, operations, structural elements, parts, or combinations thereof.

Unless defined differently, all terms used herein have the same meanings as those understood by a person skilled in the art to which the present disclosure belongs. Terms such as those defined in a generally used dictionary are to be interpreted to have the same meanings as the contextual meanings in the relevant field of art, and are not to be interpreted to have ideal or excessively formal meanings unless clearly defined in the present disclosure.

The electronic device according to one embodiment may include, for example, a portable communication device (e.g., a smart phone), a computer, a portable multimedia device, a portable medical device, a camera, a wearable device, or a home appliance. According to one embodiment of the disclosure, an electronic device is not limited to those described above.

The terms used in the present disclosure are not intended to limit the present disclosure but are intended to include various changes, equivalents, or replacements for a corresponding embodiment. With regard to the descriptions of the accompanying drawings, similar reference numerals may be used to refer to similar or related elements. A singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, terms such as “1^{st},” “2nd,” “first,” and “second” may be used to distinguish a corresponding component from another component, but are not intended to limit the components in other aspects (e.g., importance or order). It is intended that if an element (e.g., a first element) is referred to, with or without the term “operatively” or “communicatively”, as “coupled with,” “coupled to,” “connected with,” or “connected to” another element (e.g., a second element), it indicates that the element may be coupled with the other element directly (e.g., wired), wirelessly, or via a third element.

As used herein, the term “module” may include a unit implemented in hardware, software, firmware, or combination thereof, and may interchangeably be used with other terms, for example, “logic,” “logic block,” “part,” and “circuitry.” A module may be a single integral component, or a minimum unit or part thereof, adapted to perform one or more functions. For example, according to one embodiment, a module may be implemented in a form of an application-specific integrated circuit (ASIC).

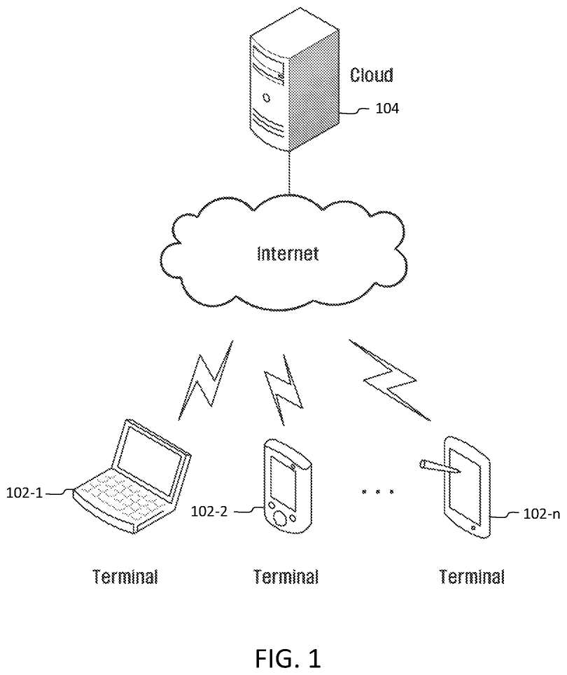

FIG. 1 is a diagram illustrating a diagram illustrating a cloud server architecture for providing a hybrid CRM system, according to an embodiment of the disclosure. In FIG. 1, one or more terminal apparatuses 102-1, 102-2, . . . , 102-n are connected to the Internet. There may be a wired connection or a wireless connection between the terminal apparatuses 102-1, 102-2, . . . , 102-n. The wireless connection can be at least one of Bluetooth®, ultra-wide band, ZigBee®, wireless fidelity (WiFi), general packet radio service (GPRS), 3rd-generation (3G) partnership project (3GPP), and long term evolution (LTE), for example. A terminal apparatus can access the Internet in a wired mode or in a wireless mode, such as through a WiFi, GPRS, 3G or LTE network.

The terminal apparatuses 102-1, 102-2, . . . , 102-n, can have at least one of a video playback, input, data collection, and communication function. For example, a terminal apparatus equipped with an image and/or audio collection device and a smart TV, usually has the above four functions, and a wearable apparatus, such as a smart watch or a smart bracelet, usually has the data collection and the communication function.

As illustrated in FIG. 1, the system further includes a cloud server 104, which can be interpreted as a cloud platform. The cloud server 104 can include at least one of standalone servers, a server group, a server cluster, and a distributed server system. A person skilled in the art can select the architecture of the cloud server 104 according to actual conditions, and the specific architecture of the cloud server 104 will not be limited in the embodiments of the present disclosure.

The cloud server 104 accesses the Internet in a wired mode, such as by accessing a wide area network or backbone network of the Internet. For example, the servers in the cloud server 104 access the wide area network of the Internet through an optical fiber.

The terminal apparatus 102-1 logs into the cloud server 104 of the serving side to register a user account, and the cloud server 104 activates the user account and records a terminal apparatus ID (e.g., universally unique identifier) to this user account.

A student admission management system may be a cloud-based platform (or another platform type) that brings together education agents, prospective students, and universities and colleges in the international education industry. Recruiting agents are businesses or individuals who are in the business of recruiting students for universities and colleges, which are classed as stakeholders in the platform. Sub-agents are freelance contractors who also recruit students for a commission. Prospective students are individuals seeking admission to study a particular course in a university or college, which are classed as stakeholders in the platform. Universities and colleges are educational institutions that grant offers of acceptance to prospective students, and are also classed as stakeholders in the platform. Stakeholders include all parties vested in the system.

The hybrid CRM system is a database management system that enables seamless integration of systems and interactions between all stakeholders, providing for the efficient management of student recruitment and enrollment processes, and the simplification of student recruitment, application management, and communication processes.

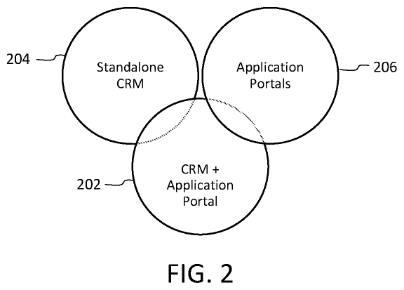

FIG. 2 is a diagram illustrating a hybrid CRM system, according to an embodiment of the disclosure. A hybrid CRM system 202 integrates a standalone computer-implemented CRM 204 and a standalone computer-implemented application portal 206, giving stakeholders access to numerous partner educational institutions, and generating a sharing commission base for recruiting agents and sub-agents.

The hybrid CRM system and database allows for the collaboration of universities, agents/counselors, students, and vendors (e.g., third party suppliers, such as flight booking companies, taxi, hotel and accommodation, etc., which are classed as stakeholders). CRM software allows all users to create and manage the students' enrollment journey, addressing all technical and business requirements.

This software allows its recruiting agent to manage their own student recruitment business and manage their sub-agents' activities in one place in order to achieve greater efficiency and to eliminate manual paper-based processes. Upon subscribing to the system, recruiting agents will have access to hundreds of highly-ranked universities, colleges, and institutions in educational hubs of Europe, North America, Australia and Asia. This access expands their choice of educational program offerings and will ultimately help to quickly scale-up their business.

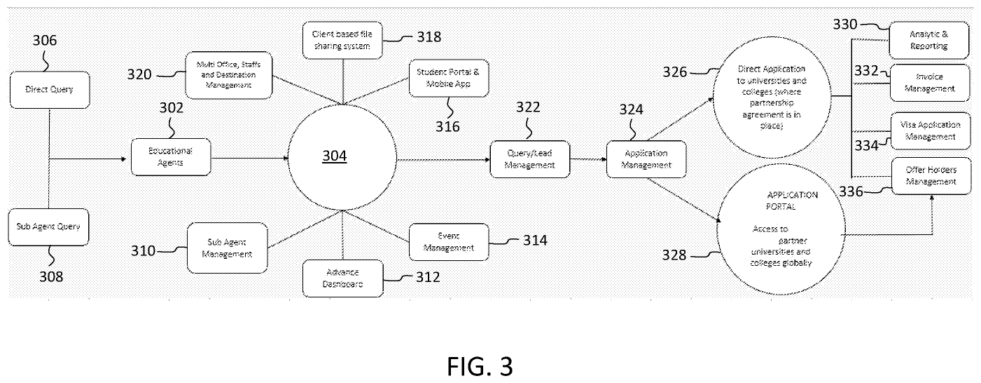

FIG. 3 is a diagram illustrating components of the hybrid CRM system, according to an embodiment of the disclosure. Recruiting agents 302 access a hybrid CRM system 304, and are fed direct queries 306 and sub-agent queries 308. The hybrid CRM system 304 provides sub-agent management 310, a user interface or dashboard 312, event management 314, a student portal and mobile app 316, a client-based file sharing system 318, office, staff, and destination management 320, and lead management 322.

The lead management 322 includes application management 324. Applications from leads, or prospective students, are fed through a direct application 326 to educational institutions with which the recruiting agent has an existing agreement, or through an application portal of the hybrid CRM system 328, which provides the recruiting agent with access to partner institutions of the hybrid CRM system.

As shown in FIG. 3, through both the direct application 326 and the application 328, the hybrid CRM system provides analytics and reporting 330, invoice management 332, visa application management 334, and offer holder management 336.

For educational institutions, the system generates additional numbers of student applicants through a growing network of recruiting agents, language centers, and individual referrals from numerous countries.

Prospective students using the system benefit from a stress free application process, and will have easy and real-time access to recruiting agents and educational institution counselors of their choice through online and mobile applications.

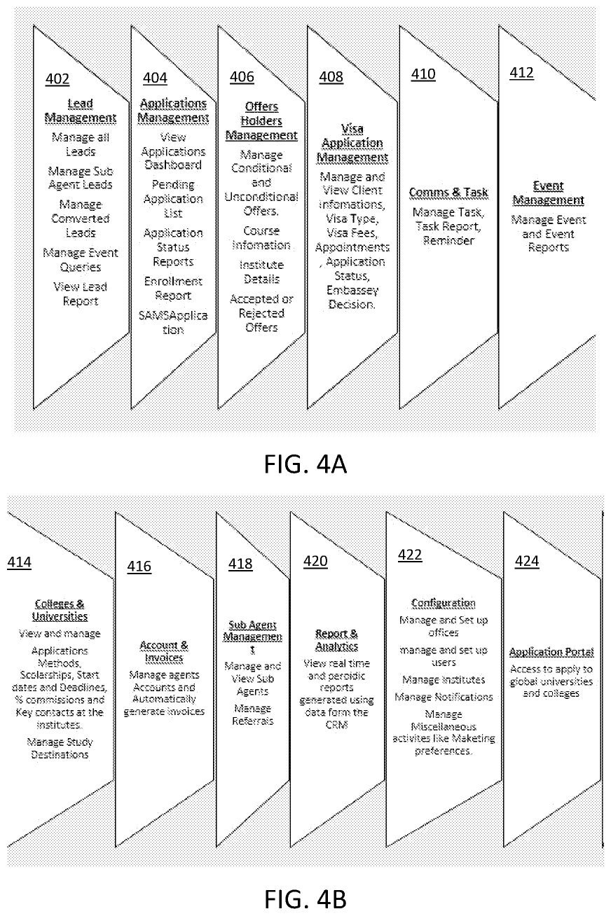

FIGS. 4A and 4B are diagrams illustrating cloud server modules for the hybrid CRM system, according to an embodiment of the disclosure. Referring initially to FIG. 4A, a lead management module 402 manages all leads, manages sub-agent leads, manages converted leads, manages event queries, and provides lead reports. An application management module 404 provides an application dashboard, a pending application list, application status reports, and enrollment reports. An offer holder management module 406 manages conditional and unconditional offers, course information, educational institution details, and accepted or rejected offers. A visa application management module 408 manages and provides client information, visa type, visa fees, appointments, application status, and embassy decisions. A communications and task modules 410 manages tasks, task reports, and reminders. An event management module 412 manages events and event reports.

As shown in FIG. 4B, a colleges and universities module 414 provides a means to view and manage applications, scholarships, start dates, deadlines, commissions, and key contacts. An invoice management module 416 manages recruiting agent accounts and automatically generates invoices to educational institutions. A sub-agent management module 418 manages sub-agents and referrals. An analytics and reporting module 420 provides real-time and periodic reports generated using data from the hybrid CRM system. A configuration module 422 manages and sets up offices, manages and sets up users, manages educational institutions, manages notifications, and manages miscellaneous activities. An application portal module 424 provides access to apply to global universities and colleges.

The disclosure relates to the field of computer-based educational customer relationship management software developed within the latest cloud and data technology.

By understanding the critical technical need for collaborating systems between universities, agents/counselors, prospective students, and vendors in a single platform, embodiments of the disclosure streamline operations and reduce time and costs by addressing these bottlenecks to achieve rapid, quality results for clients.

The disclosure includes a method, system, and computer program product for automating CRM tasks, responsive to a multichannel communication feature in which all parties can subscribe and are able to monitor, in real time, the educational recruitment process from interest to on-boarding at the educational institution.

The method includes automating CRM tasks providing recruiting agents with access to educational institutions, with which they do not have an existing contract for service, on a commission sharing bases. The method includes determining a context for real-time communications across all users and a platform for end users to share with wider access to educational institutions by indicating their interest with the click of a button on the CRM application. In response to detecting the acceptance of the service, a context is matched and a service level agreement (SLA) is generated allowing the end user to agree to the terms and condition of the SLA. Subsequent to the determination of this action, an automated task associated with the rule is triggered.

Further, the disclosure includes methods, systems, and computer program products for the management of configurable application programs on a computer-based CRM, which allows a real-time interactive mix of users and CRM system applications. Defined configurable preferences are associated with specific application features. Embodiments provide methods, systems, and computer program products that provide a more personalized management operating system across its users.

One or more contracts for services are incorporated on the system. Recruiting agents without these contracts are given access to the platform to provide applications within the context of these one or more contracts. A commission sharing agreement is initiated, signed, and applied within the system. Recruiting agents can reach more educational institutions by accessing the systems networks. This method would attract recruiting agents who would normally not have access to such educational institutions, and are interested in participating in a unique associate commission sharing program.

A method is provided for all vested stakeholders (educational institutions, recruiting agents, and students) to sign a memorandum of understanding to trigger the commission sharing on the system. A service provider provides a CRM on a server through which potential stakeholders may sign up. A prospective stakeholder visits a corresponding web site using a remote device. The prospective stakeholder signs up as an associate of the service provider, thereby becoming an associate.

As an associate, a recruiting agent approaches a potential client (e.g., a prospective student). The recruiting agent registers the potential client to the service provider's CRM. The client, or prospective student, may request an educational institution that is not currently in an agreement with the recruiting agent. The recruiting agent uses a remote device to transfer a request to the service provider's dedicated CRM platform. The recruiting agent enters data into the remote device and transmits the data to the service provider's dedicated CRM platform, thereby triggering signing of a memorandum of understanding on the system.

The prospective student's data is shared, with consent from all parties, to the service provider's dedicated CRM platform. One or more desired educational institution destinations of the prospective student are highlighted, and the system retrieves educational institutions in those desired destinations.

Applications are submitted to educational institutions, via the service provider, on behalf of the recruiting agent. In response to the submitted applications, academic offers are made by the educational institutions to the prospective student. When the prospective student accepts an academic offer and pays tuition fees, the service provider pays the recruiting agent a predetermined percentage of the commission that is paid to the service provider by the educational institution.

A system and method are provided that share an encrypted and secure database of student information via a shared feed to users/stakeholders. A database system may be implemented using a server system.

One or more student recruiting agents are identified and subscribed onto the platform, configuring one or more offices and communicating in real-time between one or more other users on the platform. A prospective student lead is identified and student data is entered into the system. Data that is to be shared between the system and the educational institution is securely accessed. The identified data is processed to auto-fill one or more application templates. Data synchronizing modeling is applied, and the data is transferred across to the university application form, with a single click. Data is received and the application form is completed.

A method and system are provided that provides real-time communication between all users, and enables all parties to subscribe and monitor the entire recruitment process from interest to on-boarding at the educational institution, in real-time. A method and system are provided in the CRM that generates real-time updates to educational institutions highlighting key management information. The updates include the number of applications submitted to their institutions, and an overall number of students unconditionally accepted. A platform is provided to maintain appointments and/or events. Prospective students may be contacted via an application portal and mobile app. Specifically, educational institutions are able to request information and send out messages through the platform. Access is provided to student profiles while adhering to data protection. This automated information aids educational institution campaigns and improves marketing performance. This may appear as a snap shot in reporting.

A method and system are provided that enable sub-agents to refer prospective students to recruiting agents using the system. The system includes an imbedded feature to manage these sub-agents by generating a comprehensive report. The report details how many referrals were made, how referrals many were converted, regions of highest and lowest conversion rates, commission fees automatically generated, and invoice generation.

There is a deep divide between CMR systems used to collect and manage data on customers, and desktop and mobile application tools that information workers use to communicate and act on this information. This division is an unnecessary barrier between the documents that discuss business information (e.g., e-mails or word processing documents between customers and a company) and the information itself (e.g., the customer record or order record in the company's CRM system).

Employees may have to leave their desktop or mobile interface frequently to view, explore, and act on the information in a separate CRM system.

The need to switch between applications is time-consuming and disruptive. When people must collaborate around information or documents, the inefficiencies may compound as colleagues must explore the same references and discover the related information repeatedly.

Thus, a system and method are provided that incorporate and integrate some functionality of a CRM system to provide access to the data used by a CRM system, with desktop and mobile tools such as, for example, document synchronization, messaging and collaboration applications, spreadsheet programs, etc.

The method may include providing, on a display of a desktop and mobile device, a user interface including a plurality of selectable links associated with actions capable of being performed on a CRM object stored or configured to be stored in a database of an on-demand database service. The selectable links are provided based on one or more attributes of the CRM. The method may also include receiving, via the user interface, a user input selecting one or more of the selectable links to request an action to be performed on the CRM, and retrieving, based on the user input selection, one or more data items from the desktop or mobile device. The method may further include automatically associating one or more data fields in the CRM with the one or more retrieved data items, and performing the requested action on the database record using the associated one or more data fields.

When a recruiting agent registers in the application, it creates offices, market countries and nationalities it serves, universities it has access to, and subagents who can share student files with them internally. Then, the recruiting agent adds users who can create a student file, referred to as a prospective student.

Along with basic information, a prospective student will have applications to different educational institutions. The recruiting agent then communicates with the educational institutions, stores important notes and reminders, sets appointments, creates tasks for that prospective student so that the prospective student can be followed up. The recruiting agent can give access to the prospective student on a student portal and mobile apps from where the prospective student can keep track of the updates.

After the prospective student has joined an educational institution, the recruiting agent can create an invoice to the educational institution according to pre-set agreements. The subscriber will have the total income transactions available in the application.

Steps that follow a recruiting agents interaction with the platform may include, for example: register; add leads (prospective students); add events/appointments/tasks/reminders; add applications; share prospective students with other internal parties; share applications with the hybrid CRM system to access a wide range of educational institutions; interact with different parties; and view business reports.

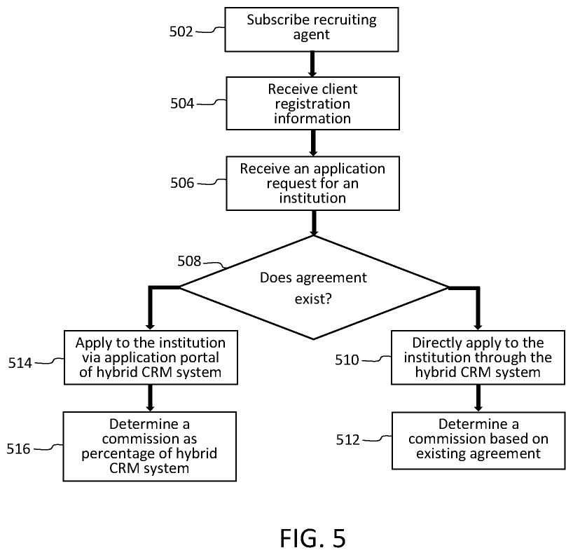

FIG. 5 is a flowchart illustrating a method for student admission management in the hybrid CRM system, according to an embodiment of the disclosure. At 502, a recruiting agent subscribes to the hybrid CRM system by providing subscription information to the hybrid CRM. The subscription information may include execution of agreements with respect commission percentages for applications submitted through the application portal of the hybrid CRM system.

At 504, the recruiting agent provides registration information of a prospective student, which establishes a profile for the prospective student in the hybrid CRM system and provides the prospective student with access to the hybrid CRM system.

At 506, the prospective student submits an application request for an educational institution through the hybrid CRM system. At 508, the hybrid CRM system determines whether the recruiting agent has an existing agreement with the educational institution.

In a case in which the recruiting agent has an existing agreement with the educational institution, the application of the prospective student is directly submitted to the educational institution by the recruiting agent, via the hybrid CRM system, at 510. The hybrid CRM system determines the commission for the recruiting agent based on the existing agreement with the educational institution, at 512. The recruiting agent may also send an invoice to the educational institution with the determined commission via the hybrid CRM system.

In a case in which the recruiting agent does not have an existing agreement with the education institution, the application of the prospective student is submitted to the educational institution through an application portal of the hybrid CRM system, at 514. The application may be auto-filled based on information provided during registration of the prospective student, and information entered in the hybrid CRM system by the prospective student. Additionally, the auto-filled application may be provided to additional educational institutions upon request by the prospective student, and may be provided to a number of educational institutions at the same time.

The hybrid CRM system determines the commission for the recruiting agent as a percentage of the commission provided to the hybrid CRM system by the educational institution, at 516. The percentage may be determined based on the agreements executed when the recruiting agent subscribed to the hybrid CRM system. The recruiting agent may send an invoice to the educational institution with the determined commission via the hybrid CRM system.

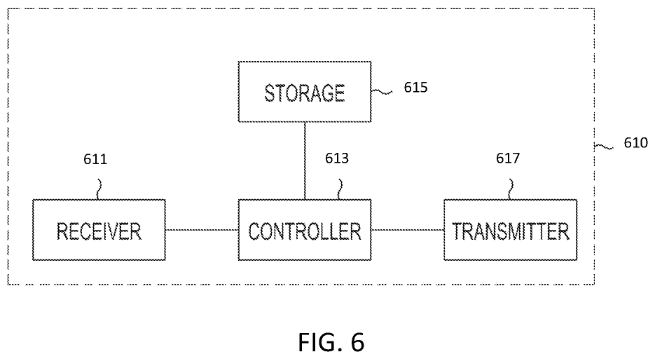

FIG. 6 is a block diagram of a cloud server, according to an embodiment of the disclosure. The cloud server of FIG. 6 may be the cloud server 104 of FIG. 1, which is used to store and execute the hybrid CRM system.

Referring to FIG. 6, a cloud server 610 includes a receiver 611, a controller 613, a storage 615, and a transmitter 617. The controller 613 controls the overall operation of the cloud server 610. In particular, the controller 613 controls the cloud server 610 to perform an operation of managing a hybrid CRM system. The operation of managing the hybrid CRM system is performed in the manner described above with reference to FIGS. 1-5. The controller 613 may include one or more controllers or processors.

The receiver 611 receives communication under a control of the controller 613. The storage 615 stores the communication received in the receiver 611 and data necessary for the overall operation of the cloud server 610. The storage 615 may include one or more non-transitory computer readable mediums. The transmitter 617 transmits communication under a control of the controller 613.

While the receiver 611, the controller 613, the storage 615, and the transmitter 617 are shown in FIG. 6 as separate units, it is to be understood that this is merely for convenience of description. In other words, two or more of the receiver 611, the controller 613, the storage 615, and the transmitter 617 may be incorporated into a single unit.

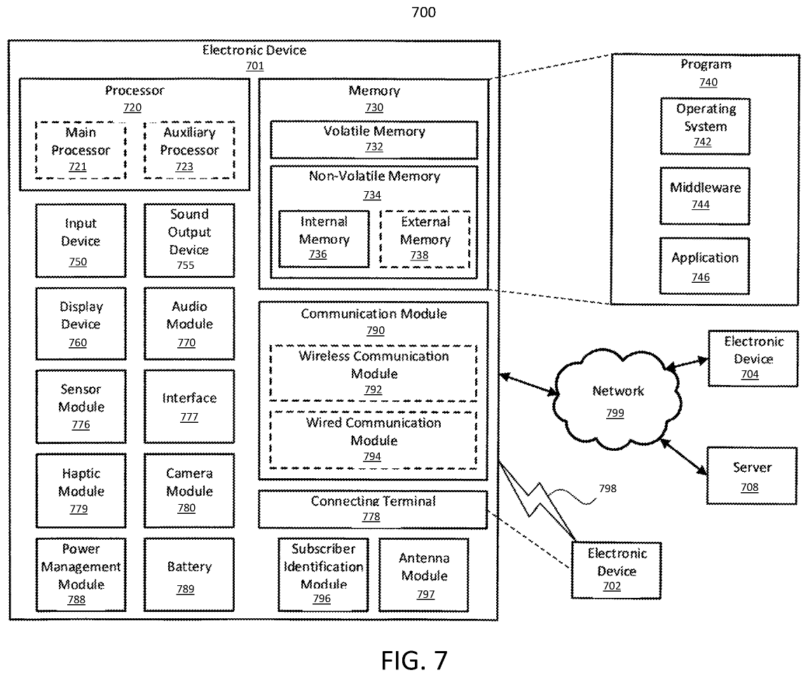

FIG. 7 illustrates a block diagram of a terminal (an electronic device 701) in a network environment 700, according to an embodiment of the disclosure. The electronic device 701 may be any one of terminals 102-1, 102-2, . . . 102-n, in FIG. 1. The electronic device 701 may be the terminal utilized by the recruiting agent or the prospective student to access the hybrid CRM system on the cloud server.

Referring to FIG. 7, the electronic device 701 in the network environment 700 may communicate with an electronic device 702 via a first network 798 (e.g., a short-range wireless communication network), or an electronic device 704 or a server 708 via a second network 799 (e.g., a long-range wireless communication network). The electronic device 701 may communicate with the electronic device 704 via the server 708. The electronic device 701 may include a processor 720, a memory 730, an input device 750, a sound output device 755, a display device 760, an audio module 770, a sensor module 776, an interface 777, a haptic module 779, a camera module 780, a power management module 788, a battery 789, a communication module 790, a subscriber identification module (SIM) 796, or an antenna module 797. In one embodiment, at least one (e.g., the display device 760 or the camera module 780) of the components may be omitted from the electronic device 701, or one or more other components may be added to the electronic device 701. In one embodiment, some of the components may be implemented as a single integrated circuit (IC). For example, the sensor module 776 (e.g., a fingerprint sensor, an iris sensor, or an illuminance sensor) may be embedded in the display device 760 (e.g., a display).

The processor 720 (or controller) may execute, for example, software (e.g., a program 740) to control at least one other component (e.g., a hardware or a software component) of the electronic device 701 coupled with the processor 720, and may perform various data processing or computations. As at least part of the data processing or computations, the processor 720 may load a command or data received from another component (e.g., the sensor module 776 or the communication module 790) in volatile memory 732, process the command or the data stored in the volatile memory 732, and store resulting data in non-volatile memory 734. The processor 720 may include a main processor 721 (e.g., a CPU or an application processor (AP)), and an auxiliary processor 723 (e.g., a graphics processing unit (GPU), an image signal processor (ISP), a sensor hub processor, or a communication processor (CP)) that is operable independently from, or in conjunction with, the main processor 721. Additionally or alternatively, the auxiliary processor 723 may be adapted to consume less power than the main processor 721, or execute a particular function. The auxiliary processor 723 may be implemented as being separate from, or a part of, the main processor 721.

The auxiliary processor 723 may control at least some of the functions or states related to at least one component (e.g., the display device 760, the sensor module 776, or the communication module 790) among the components of the electronic device 701, instead of the main processor 721 while the main processor 721 is in an inactive (e.g., sleep) state, or together with the main processor 721 while the main processor 721 is in an active state (e.g., executing an application). According to one embodiment, the auxiliary processor 723 (e.g., an image signal processor or a communication processor) may be implemented as part of another component (e.g., the camera module 780 or the communication module 790) functionally related to the auxiliary processor 723.

The memory 730 may store various data used by at least one component (e.g., the processor 720 or the sensor module 776) of the electronic device 701. The various data may include, for example, software (e.g., the program 740) and input data or output data for a command related thereto. The memory 730 may include the volatile memory 732 or the non-volatile memory 734. The memory 730 may include one or more non-transitory computer readable mediums.

The program 740 may be stored in the memory 730 as software, and may include, for example, an operating system (OS) 742, middleware 744, or an application 746.

The input device 750 may receive a command or data to be used by another component (e.g., the processor 720) of the electronic device 701, from the outside (e.g., a user) of the electronic device 701. The input device 750 may include, for example, a microphone, a mouse, or a keyboard.

The sound output device 755 may output sound signals to the outside of the electronic device 701. The sound output device 755 may include, for example, a speaker or a receiver. The speaker may be used for general purposes, such as playing multimedia or recording, and the receiver may be used for receiving an incoming call. According to one embodiment, the receiver may be implemented as being separate from, or a part of, the speaker.

The display device 760 may visually provide information to the outside (e.g., a user) of the electronic device 701. The display device 760 may include, for example, a display, a hologram device, or a projector and control circuitry to control a corresponding one of the display, hologram device, and projector. According to one embodiment, the display device 760 may include touch circuitry adapted to detect a touch, or sensor circuitry (e.g., a pressure sensor) adapted to measure the intensity of force incurred by the touch.

The audio module 770 may convert a sound into an electrical signal and vice versa. According to one embodiment, the audio module 770 may obtain the sound via the input device 750, or output the sound via the sound output device 755 or a headphone of an external electronic device 702 directly (e.g., wired) or wirelessly coupled with the electronic device 701.

The sensor module 776 may detect an operational state (e.g., power or temperature) of the electronic device 701 or an environmental state (e.g., a state of a user) external to the electronic device 701, and then generate an electrical signal or data value corresponding to the detected state. The sensor module 776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 777 may support one or more specified protocols to be used for the electronic device 701 to be coupled with the external electronic device 702 directly (e.g., wired) or wirelessly. According to one embodiment, the interface 777 may include, for example, a high definition multimedia interface (HDMI), a universal serial bus (USB) interface, a secure digital (SD) card interface, or an audio interface.

A connecting terminal 778 may include a connector via which the electronic device 701 may be physically connected with the external electronic device 702. According to one embodiment, the connecting terminal 778 may include, for example, an HDMI connector, a USB connector, an SD card connector, or an audio connector (e.g., a headphone connector).

The haptic module 779 may convert an electrical signal into a mechanical stimulus (e.g., a vibration or a movement) or an electrical stimulus which may be recognized by a user via tactile sensation or kinesthetic sensation. According to one embodiment, the haptic module 779 may include, for example, a motor, a piezoelectric element, or an electrical stimulator.

The camera module 780 may capture a still image or moving images. According to one embodiment, the camera module 780 may include one or more lenses, image sensors, image signal processors, or flashes.

The power management module 788 may manage power supplied to the electronic device 701. The power management module 788 may be implemented as at least part of, for example, a power management integrated circuit (PMIC).

The battery 789 may supply power to at least one component of the electronic device 701. According to one embodiment, the battery 789 may include, for example, a primary cell which is not rechargeable, a secondary cell which is rechargeable, or a fuel cell.

The communication module 790 may support establishing a direct (e.g., wired) communication channel or a wireless communication channel between the electronic device 701 and the external electronic device (e.g., the electronic device 702, the electronic device 704, or the server 708) and performing communication via the established communication channel. The communication module 790 may include one or more communication processors that are operable independently from the processor 720 (e.g., the AP) and supports a direct (e.g., wired) communication or a wireless communication. According to one embodiment, the communication module 790 may include a wireless communication module 792 (e.g., a cellular communication module, a short-range wireless communication module, or a global navigation satellite system (GNSS) communication module) or a wired communication module 794 (e.g., a local area network (LAN) communication module or a power line communication (PLC) module). A corresponding one of these communication modules may communicate with the external electronic device via the first network 798 (e.g., a short-range communication network, such as Bluetooth™, wireless-fidelity (Wi-Fi) direct, or a standard of the Infrared Data Association (IrDA)) or the second network 799 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 792 may identify and authenticate the electronic device 701 in a communication network, such as the first network 798 or the second network 799, using subscriber information (e.g., international mobile subscriber identity (IMSI)) stored in the subscriber identification module 796.

The antenna module 797 may transmit or receive a signal or power to or from the outside (e.g., the external electronic device) of the electronic device 701. According to one embodiment, the antenna module 797 may include one or more antennas, and, therefrom, at least one antenna appropriate for a communication scheme used in the communication network, such as the first network 798 or the second network 799, may be selected, for example, by the communication module 790 (e.g., the wireless communication module 792). The signal or the power may then be transmitted or received between the communication module 790 and the external electronic device via the selected at least one antenna.

At least some of the above-described components may be mutually coupled and communicate signals (e.g., commands or data) therebetween via an inter-peripheral communication scheme (e.g., a bus, a general purpose input and output (GPIO), a serial peripheral interface (SPI), or a mobile industry processor interface (MIPI)).

According to one embodiment, commands or data may be transmitted or received between the electronic device 701 and the external electronic device 704 via the server 708 coupled with the second network 799. Each of the electronic devices 702 and 704 may be a device of a same type as, or a different type, from the electronic device 701. All or some of operations to be executed at the electronic device 701 may be executed at one or more of the external electronic devices 702, 704, or 708. For example, if the electronic device 701 should perform a function or a service automatically, or in response to a request from a user or another device, the electronic device 701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 701. The electronic device 701 may provide the outcome, with or without further processing of the outcome, as at least part of a reply to the request. To that end, a cloud computing, distributed computing, or client-server computing technology may be used, for example.

One embodiment may be implemented as software (e.g., the program 740) including one or more instructions that are stored in a storage medium (e.g., internal memory 736 or external memory 738) that is readable by a machine (e.g., the electronic device 701). For example, a processor of the electronic device 701 may invoke at least one of the one or more instructions stored in the storage medium, and execute it, with or without using one or more other components under the control of the processor. Thus, a machine may be operated to perform at least one function according to the at least one instruction invoked. The one or more instructions may include code generated by a complier or code executable by an interpreter. A machine-readable storage medium may be provided in the form of a non-transitory storage medium. The term “non-transitory” indicates that the storage medium is a tangible device, and does not include a signal (e.g., an electromagnetic wave), but this term does not differentiate between where data is semi-permanently stored in the storage medium and where the data is temporarily stored in the storage medium.

According to one embodiment, a method of the disclosure may be included and provided in a computer program product. The computer program product may be traded as a product between a seller and a buyer. The computer program product may be distributed in the form of a machine-readable storage medium (e.g., a compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one embodiment, each component (e.g., a module or a program) of the above-described components may include a single entity or multiple entities. One or more of the above-described components may be omitted, or one or more other components may be added. Alternatively or additionally, a plurality of components (e.g., modules or programs) may be integrated into a single component. In this case, the integrated component may still perform one or more functions of each of the plurality of components in the same or similar manner as they are performed by a corresponding one of the plurality of components before the integration. Operations performed by the module, the program, or another component may be carried out sequentially, in parallel, repeatedly, or heuristically, or one or more of the operations may be executed in a different order or omitted, or one or more other operations may be added.

Although certain embodiments of the present disclosure have been described in the detailed description of the present disclosure, the present disclosure may be modified in various forms without departing from the scope of the present disclosure. Thus, the scope of the present disclosure shall not be determined merely based on the described embodiments, but rather determined based on the accompanying claims and equivalents thereto.

What is claimed is:

1. A method of a cloud server in a hybrid customer relationship management (CRM) system, comprising:
subscribing a recruiting agent to the hybrid CRM system, in response to subscription information from the recruiting agent at the hybrid CRM system;
receiving, from the recruiting agent, registration information of a prospective student, which establishes a profile of the prospective student in the hybrid CRM system and provides the prospective student with access to the hybrid CRM system;
receiving, from the prospective student, via the hybrid CRM system, an application request for an institution;
submitting, on behalf of the recruiting agent, via the hybrid CRM system, an application to the institution for the prospective student; and
determining, by the hybrid CRM system, a commission to be issued to the recruiting agent by the institution upon enrollment of the prospective student at the institution, based on the subscription information.

2. The method of claim 1, wherein the subscription information comprises execution of a commission sharing agreement by the recruiting agent for access, via an application portal, to institutions with which the hybrid CRM system has an existing agreement and the recruiting agent does not have an existing agreement.

3. The method of claim 2, wherein submitting the application comprises:
determining whether the recruiting agent has an existing agreement with the institution;
directly applying to the institution by the recruiting agent through the hybrid CRM system, when the recruiting agent has the established agreement with the institution; and
applying to the institution via the application portal of the hybrid CRM system, when the recruiting agent does not have the established agreement with the institution.

4. The method of claim 3, wherein the commission is determined based on whether the recruiting agent has an existing agreement with the institution.

5. The method of claim 1, further comprising:
issuing an invoice to the institution on behalf of the recruiting agent based on the determined commission.

6. A cloud server comprising:
at least one non-transitory computer readable medium; and
at least one controller,
wherein the at least one controller, when executing instructions stored in the at least one non-transitory computer readable medium, performs steps of:
subscribing a recruiting agent to a hybrid customer relationship management (CRM) system, in response to subscription information from the recruiting agent at the hybrid CRM system;
receiving, from the recruiting agent, registration information of a prospective student, which establishes a profile of the prospective student in the hybrid CRM system and provides the prospective student with access to the hybrid CRM system;
receiving, from the prospective student, via the hybrid CRM system, an application request for an institution;
submitting, on behalf of the recruiting agent, via the hybrid CRM system, an application to the institution for the prospective student; and
determining, by the hybrid CRM system, a commission to be issued to the recruiting agent by the institution upon enrollment of the prospective student at the institution, based on the subscription information.

7. The cloud server of claim 6, wherein the subscription information comprises execution of a commission sharing agreement by the recruiting agent for access, via an application portal, to institutions with which the hybrid CRM system has an existing agreement and the recruiting agent does not have an existing agreement.

8. The cloud server of claim 7, wherein, in submitting the application, the at least one controller further performs steps of:
determining whether the recruiting agent has an existing agreement with the institution;
directly applying to the institution by the recruiting agent through the hybrid CRM system, when the recruiting agent has the established agreement with the institution; and
applying to the institution via the application portal of the hybrid CRM system, when the recruiting agent does not have the established agreement with the institution.

9. The cloud server of claim 8, wherein the commission is determined based on whether the recruiting agent has an existing agreement with the institution.

10. The method of claim 6, wherein the at least one controller further performs a step of:
issuing an invoice to the institution on behalf of the recruiting agent based on the determined commission.

11. A method of a terminal of a recruiting agent in a hybrid customer relationship management (CRM) system:
subscribing to the hybrid CRM system on a cloud server by submitting subscription information to the hybrid CRM system;
providing registration information of a prospective student to the hybrid CRM system, which establishes a profile of the prospective student in the hybrid CRM system and provides the prospective student with access to the hybrid CRM system;
submitting, via the hybrid CRM system, an application for the prospective student to an institution requested by the prospective student; and
determining, via the hybrid CRM system, a commission to be issued by the institution upon enrollment of the prospective student at the institution, based on the subscription information.

12. The method of claim 11, wherein the subscription information comprises execution of a commission sharing agreement by the recruiting agent for access, via an application portal, to institutions with which the hybrid CRM system has an existing agreement and the recruiting agent does not have an existing agreement.

13. The method of claim 12, wherein submitting the application comprises:
directly applying to the institution through the hybrid CRM system, when the recruiting agent has the established agreement with the institution; and
applying to the institution via the application portal of the hybrid CRM system, when the recruiting agent does not have the established agreement with the institution.

14. The method of claim 13, wherein the commission is determined based on whether the recruiting agent has an existing agreement with the institution.

15. The method of claim 11, further comprising:
issuing an invoice to the institution via the hybrid CRM system based on the determined commission.

16. A terminal comprising:
at least one non-transitory computer readable medium; and
at least one controller,
wherein the at least one controller, when executing instructions stored in the at least one non-transitory computer readable medium, performs steps of:
subscribing to a hybrid customer relationship management (CRM) system on a cloud server by submitting subscription information to the hybrid CRM system;
providing registration information of a prospective student to the hybrid CRM system, which establishes a profile of the prospective student in the hybrid CRM system and provides the prospective student with access to the hybrid CRM system;
submitting, via the hybrid CRM system, an application for the prospective student to an institution requested by the prospective student; and
determining, via the hybrid CRM system, a commission to be issued by the institution upon enrollment of the prospective student at the institution, based on the subscription information.

17. The terminal of claim 16, wherein the subscription information comprises execution of a commission sharing agreement by the recruiting agent for access, via an application portal, to institutions with which the hybrid CRM system has an existing agreement and the recruiting agent does not have an existing agreement.

18. The terminal of claim 17, wherein, in submitting the application, the at least one controller further performs steps of:
directly applying to the institution through the hybrid CRM system, when the recruiting agent has the established agreement with the institution; and
applying to the institution via the application portal of the hybrid CRM system, when the recruiting agent does not have the established agreement with the institution.

19. The terminal of claim 18, wherein the commission is determined based on whether the recruiting agent has an existing agreement with the institution.

20. The terminal of claim 16, wherein the at least one controller further performs a step of:
issuing an invoice to the institution on behalf of the recruiting agent based on the determined commission.
